(19) United States
(12) Patent Application Publication
(10) Pub. No.: US 2023/0368428 A1
(43) Pub. Date: Nov. 16, 2023

(54) A Floorplan Visualisation System

(71) Applicant: LIFESIZE PLANS IP PTY LTD, Auburn, New South Wales (AU)

(72) Inventor: Christopher GHALEB, Auburn, New South Wales (AU)

(21) Appl. No.: 18/029,568

(22) PCT Filed: Oct. 4, 2021
(86) PCT No.: PCT/AU2021/051157

§ 371 Date: Mar. 30, 2023

(30) Foreign Application Priority Data
Oct. 2, 2020 (AU) 2020903582
Aug. 25, 2021 (AU) 2021107119

(51) Int. Cl. G06T 11/00; G06T 3/40; G06T 7/70; G06F 3/04883; G06F 3/04845; G06F 3/04842; G06T 7/11

(52) U.S. Cl. CPC G06T 11/00; G06T 3/40; G06T 7/70; G06F 3/04883; G06F 3/04845; G06F 3/04842; G06T 7/11; G06T 2200/24; G06T 2210/04

(57) ABSTRACT

In one embodiment, there is provided a floorplan visualisation system. The system comprises a visualisation studio; a matrix of floor mounted visual display units defining a floor surface of the visualisation studio; a controller computer comprising: a user interface; and a video output operably coupled to the matrix of visual display units for controlling the video displayed from such. In use, the controller computer is configured for: receiving floor plan representative data; segmenting the floor plan representation data into a plurality of display segments; and outputting the plurality of display segments to respective visual display units.

### TECHNICAL FIELD

The present technology relates to a floorplan visualisation system. In some embodiments, the floorplan visualisation system is a moveable floorplan visualisation system capable of being deployed in any suitable space.

### BACKGROUND

Residential and/or commercial buildings and the like are built from floorplans which are drafted, inspected, and, if necessary adjusted prior building. The floorplans are typically prepared according to a scale so as to allow the representation on A3 page format, for example.

Prior to construction, the floorplans are inspected and adjustments made accordingly. For example, the floorplans may be adjusted with reference to proposed furniture, appliances and/or other installations and according to the “feel” of the interior.

However, it is difficult to make such adjustments on paper format and sophisticated architectural 3D rendering software may be used not only to place the proposed installations but also provide a virtualisation of the interior.

However, utilisation of virtualisation software is not always adequate for determining the appropriateness of a layout or for making adjustments accordingly.

It is with at least some of these issues in mind that the present invention has been developed.

In the context of the specification, the term “floorplan” encompasses any set of images capable of providing information to a user regarding the size, shape, features and other attributes of a structure, such as a house, apartment block, or building of any type.

### SUMMARY OF THE TECHNOLOGY

Generally, at least one aspect of the invention provides a floorplan visualisation system which, within a visualisation studio, comprises a matrix of visual display panels arranged to substantially cover a a floor surface of a visualisation studio. A controller computer is utilised to provide floorplan data to each one of the matrix of visual display panels. The controller computer comprises a user interface and a display image output operably coupled to the each one of the visual display panels for controlling the image displayed on the each one of the visual display panels.

As such, the controller computer is configured for segmenting the floorplan into a plurality of segments for display by the each one of the visual display units arranged on the floor surface of the visualisation studio.

The controller computer is configured for adjusting the scale such that the displayed floor plan is to a real world (1:1) scale. As such, users, such as prospective buyers and the like may walk on the matrix of visual display panels (i.e. in operation, on the displayed floor plan) which, on account of being displayed at a real world scale, allows the user to more accurately gauge the feel and therefore appropriateness of the proposed layout within the visualisation studio.

Additionally, real size physical objects, such as chairs, tables and other furniture and appliances may be placed on the floor surface for visual inspection thereof. In one embodiment, the physical objects are arranged on wheels, rollers or an equivalent device arranged to allow easy movement of the objects from one part of the visualisation studio to another.

The controller computer may adjust the scale of the floorplan representative data accordingly for accuracy. For example, the user may utilise a user interface to make adjustments to the scale and, in embodiments, the controller computer may display a scale overlay that may be referenced when making such adjustment. In further embodiments, the controller may make interpret scale markings on the representation data or interpret scale meta data for the appropriate initial adjustment of the scale. In yet a further embodiment, the size of each one of the visual display units may be input into the controller computer, such that the controller computer is capable of adjust the scale of the image displayed on the each one of the visual display units. In this manner, different visual display units of different sizes may be utilised in the matrix.

In further embodiments, the controller computer is configured for on-floor user interaction.

For example, in one embodiment, the controller computer is configured for ascertaining the location of a user on the floor surface, such as by utilising image analysis. The controller computer may ascertain the location of the user, by, for example, communicating with a mobile computing device held by the user or carried by the user on their person. Alternatively, the controller computer may use cameras and image recognition software to identify the location of the user within the visualisation studio. In a third embodiment, the matrix of visual display units may include a pressure sensitive surface, such that the location and movement of the user may be determined by means of feedback received by the controller computer from the pressure sensitive surface.

As such, and especially for floor plans which would not fit within the surface area available within the visualisation studio, the controller computer may pan, change or otherwise manipulate the floorplan representation displayed on the matrix of visual display units according to the position of the user.

Furthermore, the floorplan representative data may be enhanced with user interaction data at associated interaction areas of the floor plan representation. For example, user interaction area may represent a stairwell such that, when the position of the user is determined to coincide with the user interaction stairwell area, the controller computer may substitute the floor plan representation with a floor plan from the floor above or beneath accordingly. As such, the user may virtually walk between floors.

The controller computer may be configured for other aspects also, such as virtual furniture, appliances or the like. Additionally, the controller computer may allow the substitution of visual images that act as overlays, so as to, for example, allow for the substitution of a carpet colour or the like within certain regions of the floorplan, such as the living areas, kitchen area or the like.

In accordance with a first aspect, there is provided a floorplan visualisation system, the system comprising: a visualisation studio; a matrix of substantially flat visual display units mounted in a manner that substantially cover the floor of the visualisation studio, the display units being capable of displaying an image; a controller computer comprising: a user interface; and a video output operably coupled to the matrix of visual display units for controlling the video displayed from such, wherein, in use: the controller computer is configured for: receiving floor plan representative data; segmenting the floor plan representation data into a plurality of display segments; outputting the plurality of display segments to respective visual display units, and wherein the controller computer is configured to receiving scale adjustment commands via a scale adjustment control of the user interface and adjust the scale of the segments to display a floor plan representation on the floor surface to a real world scale.

The floorplan visualisation system further may comprise a user position monitoring subsystem for detecting a position of a user on the floor surface. The user positioning subsystem may be provided by way of interaction with a device held by the user, or by the use of sensors, such as pressure sensors, cameras, or any other suitable sensing technology.

The controller may be configured for changing the floorplan representation according to the position of the user. Changing may include panning, and/or changing the representation of the floorplan in part or in whole.

The controller computer may be further configured for receiving floor plan interaction data representative of at least one user interaction area on the floor plan representation and an associated interaction action, and, when detecting the coincidence of the position of the user and the at least one user interaction area, the controller computer may be configured for implementing the associated interaction action.

The associated interaction action may comprise replacing the floor plan representation with another floor plan representation.

The user interface and/or the matrix of display panels may incorporate a touch sensitive user interface configured for receiving on-screen user gestures and wherein the controller may be configured for displaying corresponding markings at respective locations of the floor plan representations.

The user interface and/or the matrix of display panels may be a touch sensitive user interface configured for receiving on-screen cut and drag user gestures and wherein the controller may be configured manipulating subregions of the floor plan representation according to the cut and drag user gestures.

The controller computer may be configured for augmenting regions of the floor plan representation with at least one of a texture and colour overlay.

The controller computer may comprise a database of overlays and wherein, in use, the controller computer may be configured for receiving a selection of an overlay from the overlays via the user interface and augmenting a region of the floor plan representation utilising the selected overlay.

The floor plan representative data may comprise region representative meta data and wherein the controller computer may be configured for overlaying a region represented by the region representative meta data with the overlay.

The controller computer may be configured for determining the region representative meta data utilising image analysis of the floor plan representative data.

The controller computer may comprise a database of object representations and wherein, in use, the controller computer may be configured for receiving an object selection via the user interface and overlaying a representation of the object selection over the floorplan representation at a position specified using the user interface.

In accordance with a second aspect, there is provided a floorplan visualisation system, the system comprising: a visualisation studio including at least one wall; a matrix of substantially flat visual display units mounted in a manner that substantially cover at least a portion of the at least one wall of the visualisation studio, the display units being capable of displaying an image; a controller computer comprising: a user interface; and a video output operably coupled to the matrix of visual display units for controlling the video displayed from such, wherein, in use: the controller computer is configured for: receiving wall plan representative data; segmenting the wall plan representation data into a plurality of display segments; outputting the plurality of display segments to respective visual display units, and wherein the controller computer is configured to receiving scale adjustment commands via a scale adjustment control of the user interface and adjust the scale of the segments to display a floor plan representation on the wall surface to a real world scale.

Other aspects of the invention are also disclosed.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 shows a floorplan visualisation system in accordance with an embodiment of the present invention; and

FIG. 2 shows an exemplary illustrator floorplan visualisation studio in accordance with an embodiment of the present disclosure.

### DETAILED DESCRIPTION OF EMBODIMENTS

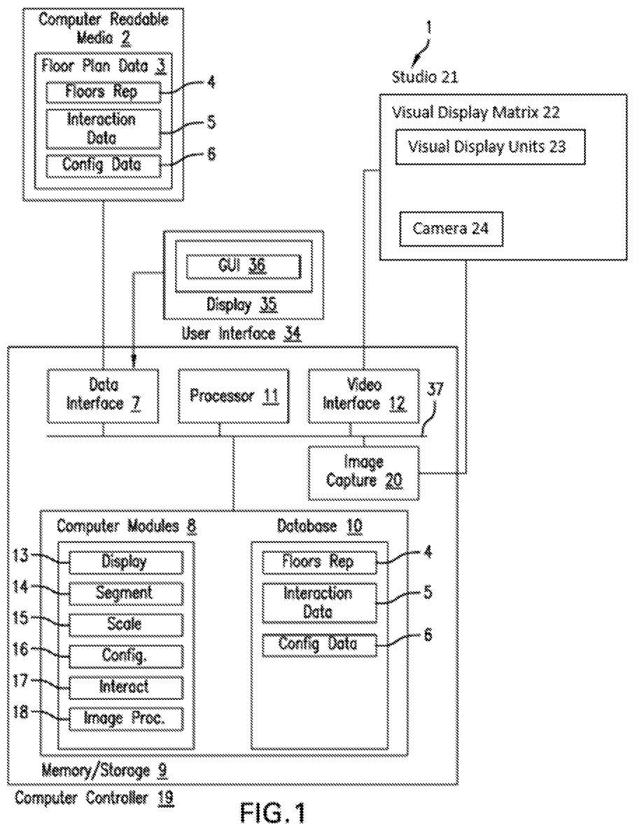

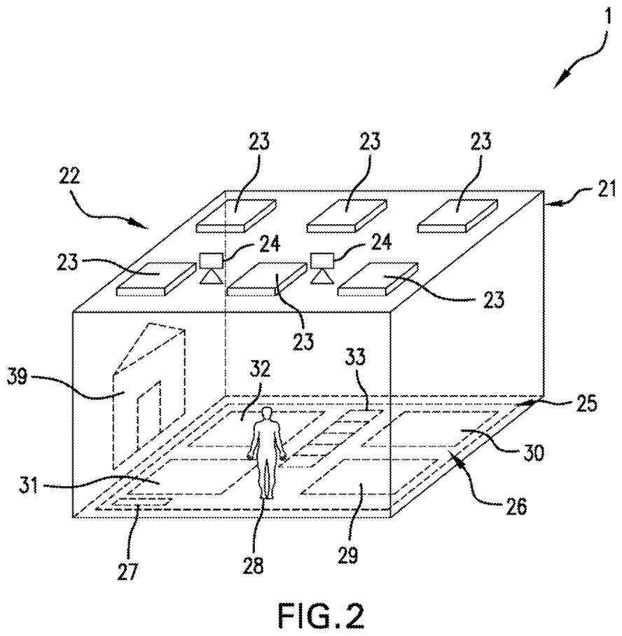

In the following detailed description of FIGS. 1 to 2, like numerals across FIGS. 1 and 2 refer to like features and/or integers.

In the embodiments described herein, there is provided a floorplan visualisation system 1. The system 1 is configured for allowing for the visualisation of floorplans, which, in a preferred embodiment, are scaled to real-world dimensions. The system 1 has application for allowing for pre-build inspection of proposed floorplans thereby preventing or reducing the likelihood of the requirement for post-construction modification.

Turning now to FIG. 1, there is shown a functional and logical schematic of the system 1 for the visualisation of scaled floorplans. The system 1 comprises a computer controller 19. As will be described in further detail below, the computer controller 19 is configured for performing the various computing tasks described herein, such as receiving floor plan data and displaying the floor plan data utilising at least one visual display panel, such as an electronic paper panel (see https://en.wikipedia.org/wiki/Electronic_paper for examples), although it will be understood that any suitable “flat screen” display panel may be utilised, including Light Emitting Diode panels, Liquid Crystal Display panels, or any other suitable technology). In the present embodiment, electronic paper display panels are utilised as they require low power consumption and “retain” an image for a period of time, even when no power is applied to the panels.

Specifically, turning now to FIG. 2, there is shown an exemplary floorplan visualisation studio 21. As can be seen, the studio 21 comprises a plurality of visual display panels 23 arranged on a floor surface 25, which may also include a pressure sensitive layer (not shown) either overlaid or incorporated into the visual display panels. In some embodiments, the panels may be overlaid with a see through protective layer, such as a Perspex layer, or other clear plastic, glass (or similar surface), to prevent scratches and provide further protection against the compressive forces exerted by users and/or furniture being placed on the panels. As can be seen, a user 28 stands on or adjacent the surface 25 so as to be able to visualise the displayed floorplan 26 for pre-build inspection.

Turning again to FIG. 1, as can be seen, the controller 19 comprises a processor 11 for processing digital data. In operable communication with the processor 11 via data bus 37 is a memory/storage device 9.

The memory device 9 is configured for storing digital data including computer program code for execution by the processor 11. Specifically, the memory device 9 may comprise a plurality of computer modules 8 configured for implementing the various functionality described herein. Furthermore, the memory device 9 may comprise a database/datastore 10 for storing various data including that which is described herein.

In embodiments, the memory device 9 may take the form of, or a combination of, volatile RAM or nonvolatile ROM memory storage and hard drive storage, including physical and solid state hard drive storage.

The controller 19 further comprises a data interface 7. The data interface 7 is configured for receiving data from various peripheral componentry, including that which is described herein. In some embodiments, the data interface 7 may be displayed on a mobile computing device, such as smartphone or tablet computing device carried by the user.

In one embodiment, the data interface 7 comprises a USB host controller but need not necessarily be limited so. [49] As is illustrated in FIG. 1, the data interface 7 is configured for reading data from a computer readable media 2, such as a USB drive or the like.

In this regard, and with reference to the embodiments described herein, the data interface 7 may be configured for receiving floor plan data 3 from the computer readable media 2 for the purposes of visualisation of the floorplans in the manner described herein.

As such, in use, the user 28 provides floorplan data 3 on a USB memory stick device or the like which may be plugged into the computer controller 19 for display purposes. However, it should be noted that the floor plan data 3 may be provided in other manners also.

The data interface 7 may be configured additionally for interacting with the user interface 34. For example, in embodiments, the user interface 34 may comprise a display device 35, such as a touchscreen LCD display device 35. In this regard, the display device 35 may display a graphical user interface 36 which may be utilised by the user 28 for interacting with the computer controller 19 in the manner described herein.

Furthermore, the computer controller 19 comprises a video interface 12 for outputting video data to at the at least one visual display unit 23 located within the floor of the studio 21. In a preferred embodiment described herein, the system 1 comprises a matrix 22 of visual display units 23 configured for the segmented display of floorplan data. As such, the viewer interface 12 may be a multi-output video interface 12 having respective outputs for each of the visual display units 23. In an alternative embodiment, the visual display units 23 may be arranged to “chain” together (i.e. directly connect with each other), with a sub-set of the visual display units being designated “master” display units (i.e. they connect to the controller 19 and receive video data from the controller 19), which are arranged to relay video data to “slave” visual display units 23. Such variations are within the purview of a person skilled in the art.

In embodiments, the system 1 may be configured for user position determination for user interaction. In this regard, in an embodiment, the system 1 may comprise image capture devices 24 for capturing image data for image processing for identifying the position of the user 28 on the floor surface. Alternatively, the position of the user may be determined by utilising the location of a portable device held by the user, such as a smartphone or tablet computing device. In a third embodiment, the pressure sensors that overlay the visual display units 23 may provide feedback data to the controller 19 to determine the location of the user.

The system 1 will now be described with reference to at least one exemplary embodiment primarily for illustrative purposes. It should be noted that these embodiments provided hereunder are exemplary only and that no technical limitation should necessarily be imputed to all of the embodiments accordingly.

With reference to FIG. 2, as alluded to above, a studio 21 may be provided for the purposes of the visualisation of floorplans. In this regard, the at least one visual display unit 23 is floor mounted so as to display, on a surface 25 within the studio 21. The surface 25, in the embodiment described, is the floor. However, it will be understood that visual display units may also be attached to at least a portion of at least one wall of the visualisation studio.

In various embodiments, the surface 25 may have dimensions of approximately 40×17 m2 but, other dimensions may also be appropriate within the purposive scope of the embodiments described herein of allowing the user 28 to visualise the displayed floorplans.

In a preferred embodiment shown in FIG. 2, the visual display units 23 are arranged in a matrix 22. In this regard, each visual display unit 22 may be configured for displaying a respective segment of the displayed floorplan 26.

Furthermore, and as alluded to above, in embodiments, the system 1 may comprise at least one image capture device 24 for capturing image data of the user 28 from the surface 25 for user interaction purposes as will be described in further detail below.

As can be seen from FIG. 2, the floorplan 26 displayed on surface 25 may display various elements of the floorplan 26 such as the bathroom 30, kitchen 29, bedroom 21 storage 32 and the like. Furthermore, in the embodiment shown, a stairwell 33 is provided. In this regard, in embodiments as alluded to above, the system 1 may be configured for in use user floorplan interaction. In these embodiments, the system 1 may determine when the user walks across the stairwell 33 so as to be able to transition floorplans to the next upper or lower levels.

Furthermore, as can also be seen from FIG. 2, the floorplan 26 may comprise a scale overlay 27 which may be referenced for adjusting the scale of the floorplan 26.

Now, having configured the studio 21 in the manner described above, a user 28 may wish to visualise floorplans 26 of a proposed building. In the embodiment described herein, the floorplans 26 comprise a number of floors for a multi-story building.

As such, the user 28 would load the floorplan data 3 onto a computer readable media 2, such as a USB memory stick or the like. As can be seen from FIG. 1, the floorplan data 3 may comprise floors 4 representing the plurality of floors. The floors 4 may be in differing formats. In one embodiment, the floors 4 are provided in PDF format. However, in other embodiments, the floors 4 may be provided in proprietary architecture software format for interpretation by the computer controller 19.

In embodiments, additional data may be loaded to the computer readable media 2 for the purposes of enhancing the user experience in the visualisation of the floorplan 26. Specifically, as can be seen, the floorplan data 3 may further comprise interaction data 5. Such interaction data 5 may be utilised for the purposes of user interaction in embodiments, as will be described in further detail below.

Furthermore, various configuration data 6 may also be provided in association with the floor data 4. Such configuration data 6 may configure various aspects including the manner in which the floors 4 are to be displayed such as the colouring, scale and the like. Furthermore, the configuration data 6 may configure the order of the floors 4 in height elevation order. [66] Arriving at the studio 21, the computer readable media 2 is inserted into the data interface 7 for reading.

The controller 19 may read the floorplan data 3 from the computer readable media 2 which may then be stored within the database 10. As can be seen, the database 10 may replicate the various data including storing the floors 4, interaction data 5 and configuration data 6.

It should be noted that, in embodiments, such data need not necessarily be stored within the database 10 in lieu of the controller 19 utilising the data directly on the computer readable media 2.

Now, as can be seen, the computer modules 8 may comprise a display module 13 for the purposes of displaying the floorplan 26. Specifically, the display module 13 converts the floorplan data 3 into an appropriate format for output via the video interface 12 for display by the visual display matrix 22. As alluded to above, the display module 13 may act in accordance with the configuration data 6 specifying aspects such as the manner in which the floorplan 26 is to be displayed, the scaling of the floorplan and the like.

As can be seen, the computer modules 8 may further comprise a segmentation module 14 for segmenting the floorplan 26 across the various visual displays 23. Specifically, in the embodiment shown in FIG. 2, a matrix 22 of six visual displays 23 may be provided. In this regard, the segmentation module 14 may segment of the floorplan 26 into six corresponding segments for respective display by the six visual displays 23.

In embodiments, the visual displays 23 may have a “border” or “edge” which is not capable of displaying an image. In this embodiment, the controller 19 may be configured for adjusting the location of the various segments such that the total image displayed remains to scale, even though a small portion of the image at the edge of each visual display unit is not displayed.

The computer modules 8 may further comprise a scaling module 15 configured for scaling the floorplans 26 appropriately. In embodiments as alluded to above, the scaling module 15 may be configured for interpreting scaling data within the configuration data 6.

For example, the floorplan data 3 may specify a scale, and being configured in accordance with the dimensions of the total surface 25, the scaling module 15 is configured for scaling the floorplans appropriately such that the floorplan 26 scale to real-world dimensions.

As such, the floorplan items would appear to the user 20 standing on the total surface 25 as being of a real-world size. As such, the user is able to visibly ascertain the sizing of the floorplans so as to be able to take remedial action if necessary in anticipation of building.

In embodiments, the scaling module 15 may interpret scale data of the floor plan representation such as by performing optical character recognition (OCR) and width measurements of scales displayed thereon. Alternatively, the scaling module 15 may interpret scaling meta data accompanying the representation data.

In embodiments, the computer modules 8 may comprise a configuration module 16 for allowing for the configuration of the displayed floorplan 26. In one embodiment, the configuration module 16 is configured for allowing the user adjustment of the scaling of the displayed floorplan 26.

For example, in the embodiment alluded to above, the display module 13 may be configured for overlaying a scale overlay 27 on the floorplan 26. Such a scale overlay 27 may have a set length, such as a length of 1 m or the like. As such, the user may place a physical object of the same dimension, such as a meter rule adjacent the scale overlay 27 so as to be able to adjust the scaling of the floorplan 26 accordingly. Specifically, should the length of the meter rule and the scale overlay 27 be incongruent, the user may utilise the user interface 34 to increase or decrease the scale of the display floorplan 26.

For example, the user interface 34 may display a scale adjustment control, such as a slider control, which the user may utilise to issue scale up and scale down adjustments wherein the scaling module 15 makes the necessary adjustments. As such, the user would adjust the scale adjustment controller until such time that the virtual scale overlay 27 coincides in length with the reference object.

In further embodiments, the system 1 may analyse image data captured by the image capture devices 24 to make image adjustments. For example, for a floorplan scale legend, the controller 19 may determine the actual displayed length thereof on the floor surface of the studio utilising image data captured by the image capture devices 24 so as to make necessary adjustments. So as to be able to ascertain the appropriate scale of the floorplan scale legend, the controller may further implement OCR of the floorplan representations to read and interpret the appropriate scale.

In other embodiments, the configuration module 16 may allow the user to configure other aspects of the displayed floorplan 26, such as colouring and the like. For example, the floorplan 26 may be displayed with white or black backgrounds. Such configuration may similarly be implemented by the user 28 utilising the user interface 34.

In embodiments, the computer controller 19 may be configured for in use user floorplan interaction. In this regard, the controller 19 may comprise an interaction module 17 configured for implementing the various user interactions described herein.

In one embodiment, the controller 19 may allow the user to switch between various floors 4 of the floorplan data 3. For example, utilising the user interface in 34, the user 28 can switch between a plurality of candidate floorplans 26. In alternative embodiments the user 28 may switch between upper and lower floors utilising the user interface 34. For example, the user may initially view the ground floor and then subsequently view the first floor of a building plan.

In embodiments, the controller 19 may be configured for determining a position of the user 28 for the purposes of user interaction. In this regard, and as alluded to above, the studio 21 may comprise at least one camera 24 configured to capture an image of the user 28 so as to allow the controller 19 to determine the relative position of the user 28. In this regard, the computer modules 8 may comprise an image processor module 18 for interpreting the image data received by the image capture interface 20 for determining the position of the user. In other embodiments, other sensor types may be utilised for determining the location of the user.

Now, having determined the relative positioning of the user, in embodiments, the display module 13 may be configured for panning the floorplan 26 in accordance with the location of the user 28. For example, should the real world scale of the floorplan 26 exceed the available surface area of the surface 25, the display module 30 may be configured for panning the floorplan 26 as the user moves about the surface 25. For example, as the user 28 approaches an edge of the surface 25, the display module 13 may pan the floorplan 26 in the opposite direction away from the approached edge so as to allow the user to view 28 the formerly clipped edge of the floorplan.

In alternative embodiments, the detected positioning of the user 28 may be utilised for the user interaction purposes. For example, in embodiments, the controller 19 may be configured for determining the coincidence of the user position and an interaction area.

Specifically, and as alluded to above, the displayed stairwell 33 may be designated as an interaction area by the interaction data 5 of the floorplan data 3.

As such, as the controller 19 determines that the position of the user 28 coincides with the stairwell interaction area 33, the controller 19 may take on appropriate action such as transition to the next floor. As such, the user may approach the stairwell to visually walk up or down flights of stairs.

In embodiments, the configuration data 6 may comprise surface rendering data controlling how the floorplans 26 are to be displayed. Specifically, the configuration data 6 may comprise various surface rendering swatches or the like which may be toggled or selected utilising the computer controller 19 such that the displayed floorplans 26 or updated accordingly. Specifically, in this embodiment, differing floor types, carpet types, colours and the like may be displayed substantially dynamically on the floorplan 26. The database 10 may comprise such rendering data that may be applicable to all floorplans provided.

The floorplan representation data 4 may comprise demarcation meta data demarcating various types of areas and therefore flooring of the floorplan representation. For example, the demarcation meta data may determine a corridor area as opposed to a kitchen area so as to allow the user to quickly switch between differing floor types, such as different types of carpet types for the corridor area and differing types of non-carpeted types for the kitchen area. In embodiments, the controller 19 may implement continuity analysis of the floorplans so as to be able to intelligently “fill” connected areas of the floorplans with a chosen floorplan type.

Where at least a portion of a wall includes visual display units, the user 28 may view the house elevation plan 34 against the studio wall 21. In this manner, the user may make modifications to the house if required, such as by changing the locations of exterior doors, windows, renders, facades and the like.

In this embodiment, the rendering of the house elevation plan 34 may further be configured in accordance with the configuration data 6 so as to allow the user to switch between differing exterior renders, paint finishes and the like.

In embodiments, the elevation plan 34 may represent an inside display of the proposed building wherein, in embodiments, the display of the elevation plan 39 has an interworking relationship with the displayed floorplan 26 such that the elevation plan 34 displayed corresponds, at its base, with the corresponding floorplans. As such, for example, for the kitchen 29 displayed within the floorplan 26, the user may additionally be able to view the elevation view of the interior of the kitchen 29 as is displayed by the elevation plan 34.

In embodiments, the elevation plan 34 may be generated dynamically by the computer controller 19 in accordance with the floorplan data 4 and the configuration data 6. For example, the computer controller 19 in accordance with the configuration data 6 may dynamically render the elevation plan 34 such as, for example, by dynamically generating the interior paint colour and dynamically allocating doors, windows, and other interior household features such as kitchen fittings and the like. In embodiments, the dynamic generation of the interior elevation plan 34 may be generated in accordance with user provided parameters (such as where, for example, the user was to specify the kitchen componentry type) and pseudorandom generated features, such as where the computer controller 19 randomly places various furniture, pot plants, picture paintings and the like.

In embodiments, partitions, barriers and false walls may be used to help the user visualise the depth of enclosed spaces. Such partitions may be aligned with the boundaries of the displayed floor plans 26 and may include visual displays 23. The use of multiple visual displays 23 may assist in the floorplan visual display 26 being displayed on the vertical partitions.

Additionally, physical and mobile furniture beds, cupboards, tables, chairs, lounges, TV units and the like may be placed at appropriate locations within the displayed boundaries of the displayed floorplans 26 to further assist the user visualisation process so as to be able to make informed decisions as to layout, lost space for furniture and the like. In alternative embodiments, virtual furniture objects may be displayed by the controller 19 which may be “physically” grabbed by the user for relocation, either by utilising gestures which are detected by the cameras 24 or which are controlled using the touch sensitive display 24.

Furthermore, in embodiments, the computer controller 19 may be configured to add or remove displayed lines from the displayed floorplans 26 in substantial real time during the visualisation process.

Furthermore, the computer controller 19 may be configured to allow the taking of measurements. In one embodiment, the display 35 may be utilised for placing pointers, rulers or the like for the purposes of taking measurements. In alternative embodiments, a visually apparent ruler, measuring tape or the like may be placed across the display surface 26 which is detected by the cameras 24 so as to be able to take measurements. For example, in one embodiment, the user may roll out a pink measuring tape across the display surface 26 which is detected by the cameras 24. The controller 19 then take the measurement reading in accordance with the length of the detected tape measure and then protects the measurement reading adjacent the tape measure. In embodiments, area may also be correlated in a similar manner.

In further embodiments, the system 1 to receive writing gestures by the user interface 34 so as to be able to display corresponding writing on the floor surface. For example, the user interface 34 may take the form of a mobile computer device held by the user while walking the floor surface. As such, at appropriate locations, the user may virtually write and mark on the floor surface making appropriate marks on the user interface 34. For example, the user may make a marking where a wall should be moved.

In further embodiments, utilising similar gestures, the user may modify the displayed floor plan representation data utilising cut, move and place gestures. For example, the user may draw a bounding rectangle around a wall to be moved and then, utilising drag gestures, drag the selected area to a new area which may then be placed. As a result of such an editing process, the controller 19 may output modified floor plan representation data which may be utilised as a basis for amendments. [102] Furthermore, in embodiments, the controller 19 may be configured for the automated generation of design changes that have been decided upon during the visualisation process which may then be provided to architects, engineers, certifiers and the like for implementation.

### Advantages

One of the advantages of the embodiments and broader invention described herein is that the device provides a cost effective, reliable and moveable device for visualising floorplans at a “life-size” scale.

### Definition and Clarification of Terms

Throughout this specification, unless the context requires otherwise, the word “comprise” or variations such as “comprises” or “comprising”, will be understood to imply the inclusion of a stated integer or group of integers but not the explicit exclusion of any other integer or group of integers.

Those skilled in the art will appreciate that the embodiments described herein are susceptible to obvious variations and modifications other than those specifically described and it is intended that the broadest claims cover all such variations and modifications. Those skilled in the art will also understand that the inventive concept that underpins the broadest claims may include any number of the steps, features, and concepts referred to or indicated in the specification, either individually or collectively, and any and all combinations of any two or more of the steps or features may constitute an invention.

Where definitions for selected terms used herein are found within the detailed description of the invention, it is intended that such definitions apply to the claimed invention. However, if not explicitly defined, all scientific and technical terms used herein have the same meaning as commonly understood to one of ordinary skill in the art to which the invention belongs.

1. A floorplan visualisation system, the system comprising:
a visualisation studio; a matrix of floor mounted visual display units defining a floor surface of the visualisation studio; a controller computer comprising:
a user interface; and a video output operably coupled to the matrix of visual display units for controlling the video displayed from such, wherein, in use:
the controller computer is configured for: receiving floor plan representative data; segmenting the floor plan representation data into a plurality of display segments; and outputting the plurality of display segments to respective visual display units, and wherein the controller computer is configured to receiving scale adjustment commands via a scale adjustment control of the user interface and for adjusting the scale of the segments to display a floor plan representation on the floor surface to a real world scale.

2. A floorplan visualisation system as claimed in claim 1, further comprising a user position monitoring subsystem for detecting a position of a user on the floor surface.

3. A floorplan visualisation system as claimed in claim 2, wherein the system further comprises an image capture device and wherein the position of the user is determined utilising image processing of image data captured by the image capture device.

4. A floorplan visualisation system as claimed in claim 2, wherein the controller is configured for changing the floorplan representation according to the position of the user.

5. A floorplan visualisation system as claimed in claim 2, wherein the controller computer is further configured for receiving floor plan interaction data representative of at least one user interaction area on the floor plan representation and an associated interaction action, and, when detecting the coincidence of the position of the user and the at least one user interaction area, the controller computer is configured for implementing the associated interaction action.

6. A floorplan visualisation system as claimed in claim 5, wherein the associated interaction action comprises replacing the floor plan representation with another floor plan representation.

7. A floorplan visualisation system as claimed in claim 1, wherein the user interface is a touch sensitive user interface configured for receiving on-screen user gestures and wherein the controller is configured for displaying corresponding markings at respective locations of the floor plan representations.

8. A floorplan visualisation system as claimed in claim 1, wherein the user interface is a touch sensitive user interface configured for receiving on-screen cut and drag user gestures and wherein the controller is configured manipulating subregions of the floor plan representation according to the cut and drag user gestures.

9. A floorplan visualisation system as claimed in claim 1, wherein the controller computer is configured for augmenting regions of the floor plan representation with at least one of a texture and colour overlay.

10. A floorplan visualisation system as claimed in claim 9, wherein the controller computer comprises a database of overlays and wherein, in use, the controller computer is configured for receiving a selection of an overlay from the overlays via the user interface and augmenting a region of the floor plan representation utilising the selected overlay.

11. A floorplan visualisation system as claimed in claim 9, wherein the floor plan representative data comprises region representative meta data and wherein the controller computer is configured for overlaying a region represented by the region representative meta data with the overlay.

12. A floorplan visualisation system as claimed in claim 11, wherein the controller computer is configured for determining the region representative meta data utilising image analysis of the floor plan representative data.

13. A floorplan visualisation system as claimed in claim 1, wherein the controller computer comprises a database of object representations and wherein, in use, the controller computer is configured for receiving an object selection via the user interface and overlaying a representation of the object selection over the floorplan representation at a position specified using the user interface.
